(19) United States
(12) Patent Application Publication
(10) Pub. No.: US 2007/0136085 A1
(43) Pub. Date: Jun. 14, 2007

(54) Personalized gemstone certificate card

(76) Inventors: Randall M. Wagner, Mequon, WI (US); Glenn A. Cassens, Mequon, WI (US); Kurt P. Schoeckert, Hartford, WI (US)

Correspondence Address: COOK & FRANKE S.C., 660 East Mason Street, Milwaukee, WI, 53202, US

(21) Appl. No.: 11/512,005

(22) Filed: Aug. 28, 2006

Related U.S. Application Data
(60) Provisional application No. 60/711,982, filed on Aug. 26, 2005.

(51) Int. Cl. G06Q 99/00

(52) U.S. Cl. 705/1

(57) ABSTRACT

The invention is a personalized gemstone certificate card (PGCC) and on-line process for generating the PGCC document. The PGCC is a personalized, special occasion greeting card and gemstone certification for commemorating the gift of a gemstone or jewelry piece. The PGCC is given with the gemstone to a recipient. The PGCC is generated by an author from their personal computer that is linked to a host server and website via the internet. The card has a personalized section and a gemstone certificate section. The personal section includes text, color, materials and images selected and arranged by the author. The grading section includes certification information provided by the grading authority. The PGCC can be viewed as an electronic document by the recipient via their personal computer, or printed and mailed or given to the recipient with the gemstone or jewelry gift.

### TECHNICAL FIELD OF THE INVENTION

This invention relates to a personalized gemstone certificate card that includes gemstone grading information, images, measurement information and personal information, and process of producing the certificate card.

### BACKGROUND OF THE INVENTION

The diamond industry is dependent on the consumers trust in the quality of the product, in this case the gemstone or diamond, as measured by common criteria. This criteria typically includes the color, clarity, carat weight and cut of the gemstone or diamond, which are commonly referred to as the 4C's. These measurements are done by human observation and are reported on a document given to the customer, commonly called grading certificate as shown in FIG. 1. These documents are printed, generally containing text and two dimensional graphs and/or pictures. The paper document can be converted to a digital picture for viewing on a computer monitor or a web browser.

Grading certificates can include light performance information along with the 4C's. An example of such a grading certificate is the GemEx Light Performance Report or GemEx Report shown in FIG. 2. This report includes grading elements pertaining to the 4C's and images and information obtained from gemstone light performance instruments such as the GemEx BrillianceScope® light performance instrument described in U.S. Pat. No. 5,615,005, the disclosure of which is incorporated herein. The light performance instrument measures elements of light reflection and refraction of a diamond using digital spectrophotometry and advanced digital imaging software. These images are color images showing the visual appearance of the gemstone under one or more lighting conditions. This digital information is printed on paper similar to a traditional diamond certificate for use by the selling professionals and the retail consumer. The GemEx reports or certificates include six-color digital images and calculated measurements obtained from the output of the BrillianceScope light performance instrument.

A problem with conventional gemstone certificates is that they provide no sentimental value. Conventional gemstone and diamond grading certificates are documents of record that convey technical measurements and subjective or objective ratings of observed features of the cut diamond. Although grading certificates are considered quite important to the consumer, the documents are of no value by themselves, i.e., there is no intrinsic value or sentimental value attached to the certificate. Most certificates are made to look authoritative and officious so as to project a seriousness and trustworthiness about them. They purposely try to be quite formal so as to enhance the perception of credibility of the grading authority.

Greeting cards, gifts, and commemorative miscellanea are often given to memorialize special occasions and events in someone's life, like a birthday or wedding, and many times accompany gifts given for special occasions. When the gift is jewelry or diamonds, the occasion is probably more special than temporal congratulations or passing sentiment and is likely a time that people want to remember and memorialize with the expense and permanence of a diamond. When this happens, the receiver of the jewelry or diamond is given a greeting card expressing the sentiment and importance of the occasion. A separate grading certificate authenticating the jewelry or diamond is also given to the recipient.

Greeting cards have traditionally been printed on paper. The cards are placed in an envelope and delivered in person or by mail. The cards are purchased at any of the many stores that sell greeting cards. More recently, with the age of the internet, greeting cards can now be in the form of digital electronic files that are sent via e-mail and viewed on a video display of a computer or other device. The cards can be ordered online and delivered electronically or in printed form, or both. Ordering greeting cards online is now quite common and follows several different formats including purchasing a standard pre-designed card, customizing a standard pre-designed format, or designing a card format from scratch. When customizing or designing a card from scratch, the buyer will visit a web-site offering these products and will go through a pre-programmed routine which allows them to view and select different features, including text, colors and images, and even allows them to up-load their own digital photographs for inclusion in the design.

The advent of the internet created a number of vendors offering electronic greeting cards that can be printed like a traditional card. Many of those online-offerings include the ability to customize the greeting with personal information, text, video and digital photographs. Such technology for creating the personalized greeting card is widely distributed and there are various ways to provide the customizing feature without inventing new protocols or processing technology. However, at this time, there is no offering of a commemorative gift card or gemstone certificate that embodies both the sentiment expressed in a typical greeting card and the authoritative information in the diamond grading certificate.

The present invention is intended to solve these and other problems.

### BRIEF DESCRIPTION OF THE INVENTION

The personalized gemstone certificate card (PGCC) is a personalized, special occasion greeting card and gemstone certification for commemorating the gift of a gemstone, diamond or jewelry piece. The PGCC is designed or authored by or for a person purchasing or giving the gemstone to another person or the recipient. The card contains text, color, materials and images selected and arranged by the author, along with the gemstone certification information provided by the grading authority. The creation of the PGCC produces a combination keep-sake card and gemstone grading certificate, memorializing the occasion and sentiment of the gift, along with the official description of the diamond, attesting to the importance of the gift.

An advantage of the present PGCC invention is its ability to capture and convey the sentiment of the person or persons giving the gemstone gift or the sentimental value of the gemstone itself. The personalization may include information or symbols to designate the importance of the gift, personal information about the giver or the recipient, descriptions and information about the occasion of the purchase or gift, or the emotional meaning of the gift, such as a wedding engagement or anniversary ring.

Another advantage of the PGCC invention is its compact combination of information. The PGCC merges the sentiment of the benefactor, occasion and gift with the official gemstone grading certificate information. The PGCC ties the sentiment and grading information together into a single document so that one is not separated from the other. The single document is stored as an electronic document, a paper document or both for easy retrieval years later. Thus, the attention placed on saving the official information for the gemstone or jewelry piece is also provided to the sentimental information, and visa versa. This ensures that the complete value of the gemstone or jewelry is not lost or forgotten over time by the recipient, and can be easily matched with the gemstone or jewelry as it is passed on from one generation to the next.

A further advantage of the PGCC invention is its accessibility, privacy and ease of use. The author of the PGCC is able to create the design on their own personal computer linked to the internet via a web-browser enabled with a software program located on a host server, such as GemEx's internet servers. The software and host server allow the author to select design features, images, video, audio and text files from a stock inventory. The software and host server also allow the author to compose his or her own text or audio files. The author can alternatively create additional personalization by uploading his or her own images, video files, audio files, fonts and design features. This personalized design of the card is merged with the information and images of the gemstone grading certificate or GemEx Report to form a combined personalized gemstone certification card or PGCC. The PGCC is saved electronically in an archive database such as that of the owner of the host server. The PGCC is then purchased and delivered electronically as a viewable file on a standard PC, printed for viewing from a standard PC printer, or printed as a professionally printed special occasion card or document.

A still further advantage of the present PGCC invention is its speed. The printed card is produced within a forty-eight hours turn-around time, and the card is delivered to any location worldwide by the method selected by the author of the card.

A still further advantage of the PGCC invention is its marketing flexibility. The PGCC product may be sold to professional retail jewelers for resale to the gemstone, diamond or jewelry buyer, or sold direct to the gemstone, diamond or jewelry buyer via the internet and web-site.

A still further advantage of the electronic PGCC file is that it can be merged or interfaced with gemstone light performance images and measurement information. For example, the electronic PGCC file can be merged to include some or all of the images and measurement information using a standard web browser for viewing and manipulating the report information and spectrophotometric gemstone or diamond images via software controls. This enables the observer to make comparisons and personal judgments about the gemstone, diamond or jewelry piece based on his or her own observation of the images. The observer is able to reveal and shape the presentation of the spectrophotometric information according to his or her personal preferences.

Other aspects and advantages of the invention will become apparent upon making reference to the specification, claims and drawings.

### BRIEF DESCRIPTION OF THE DRAWINGS

FIG. 1 is a print out of a conventional gemstone grading certificate for a diamond.

FIG. 2 is a print out of a conventional light performance report for a diamond.

FIG. 3 is a schematic diagram showing a diamond gemstone passing from one person such as a groom to another person such as a bride on a sentimental occasion such as a wedding, and the flow of manufacture, stock library and personal information and images to generate a personalized gemstone certificate card (GGCC) document via a personal computer linked to the host server via the internet.

FIG. 4 is a chart showing the steps for generating and ordering a PGCC document.

FIG. 5 is a printout of a first example of a printed PGCC product for a single diamond.

FIG. 6 is a printout of a second example of a printed PGCC product for three diamonds.

### DESCRIPTION OF THE PREFERRED EMBODIMENTS

While this invention is susceptible of embodiment in many different forms, the drawings show and the specification describes in detail a preferred embodiment of the invention. It should be understood that the drawings and specification are to be considered an exemplification of the principles of the invention. They are not intended to limit the broad aspects of the invention to the embodiment illustrated.

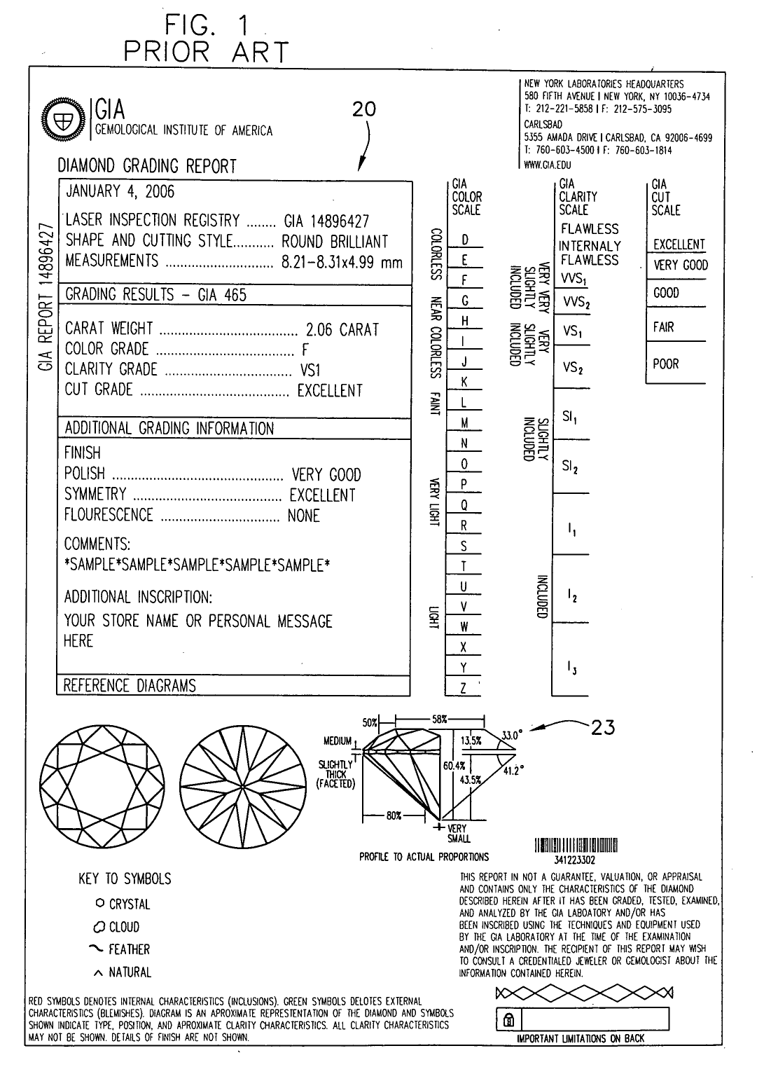

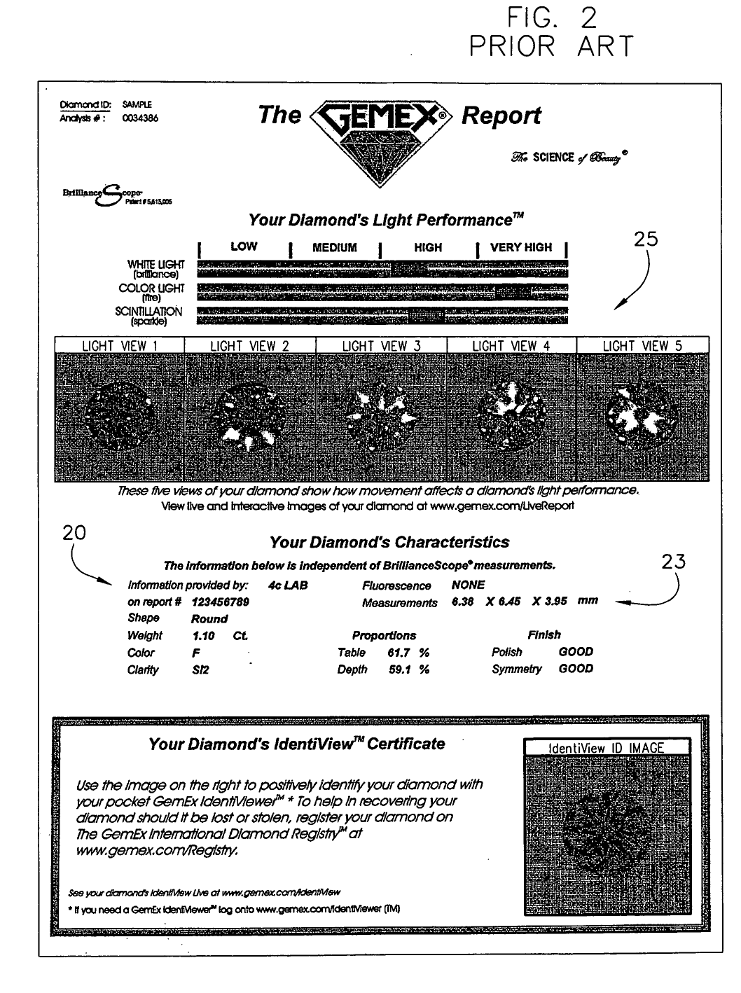

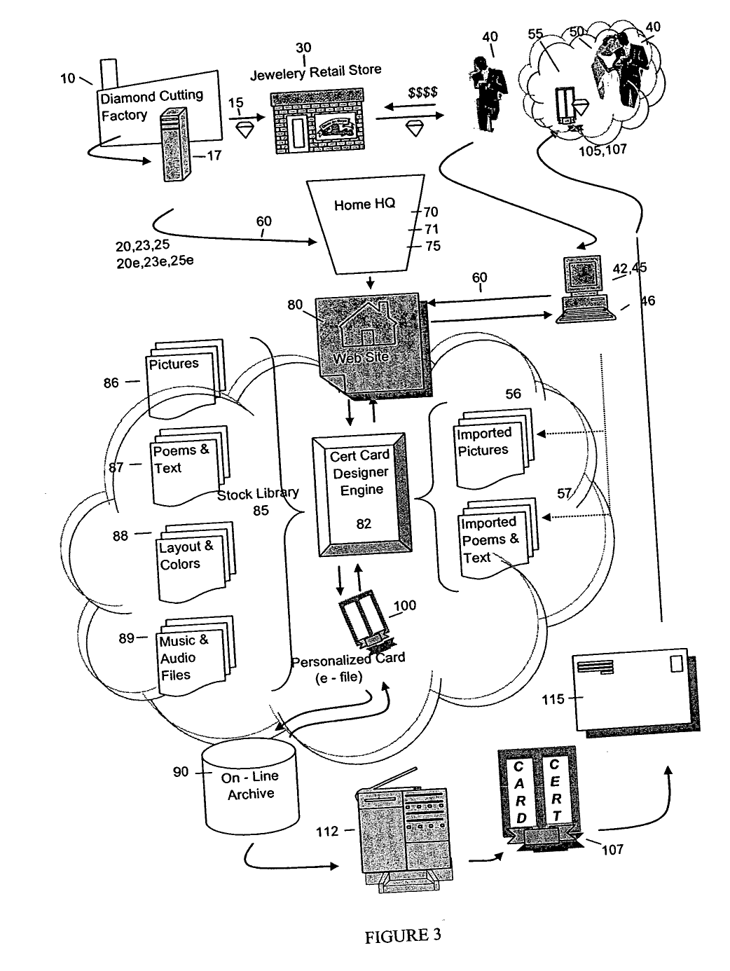

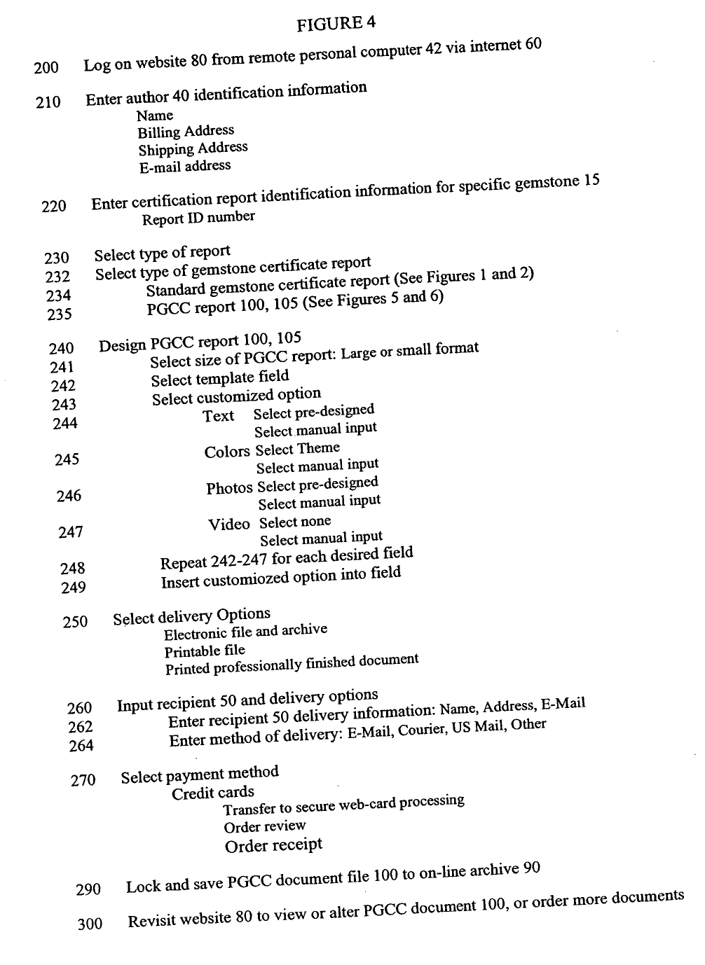

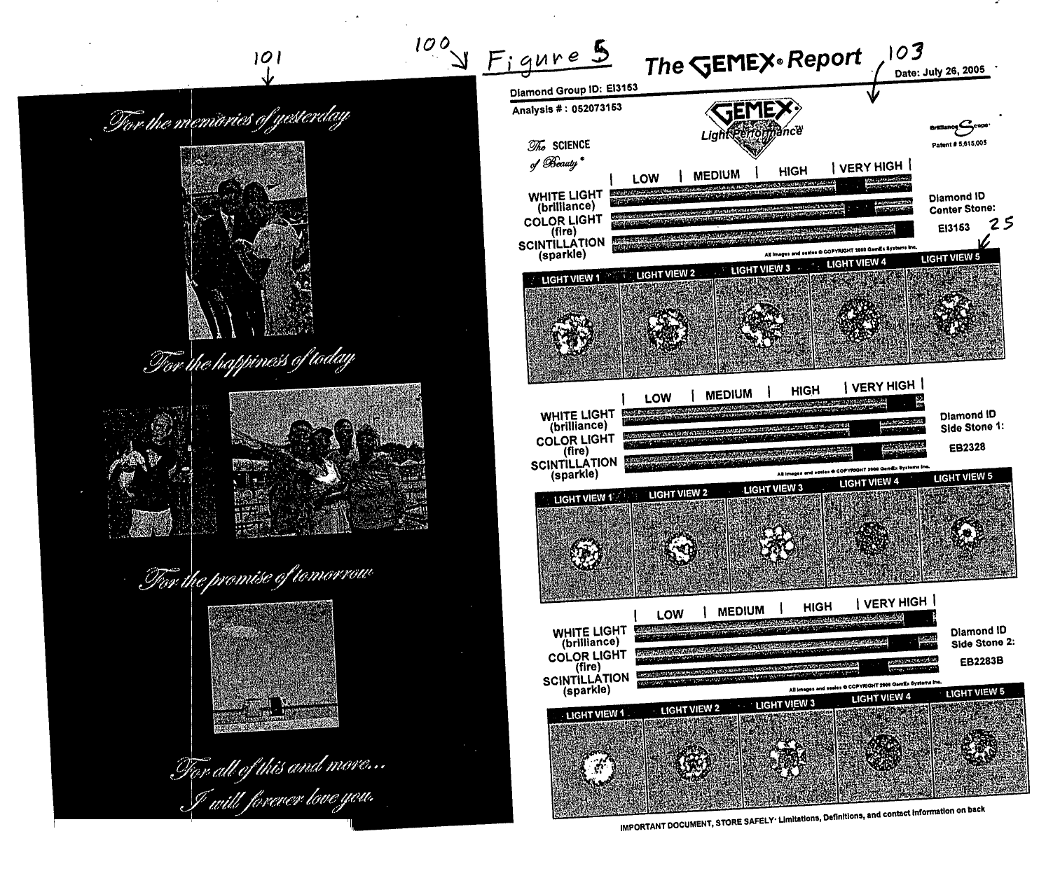

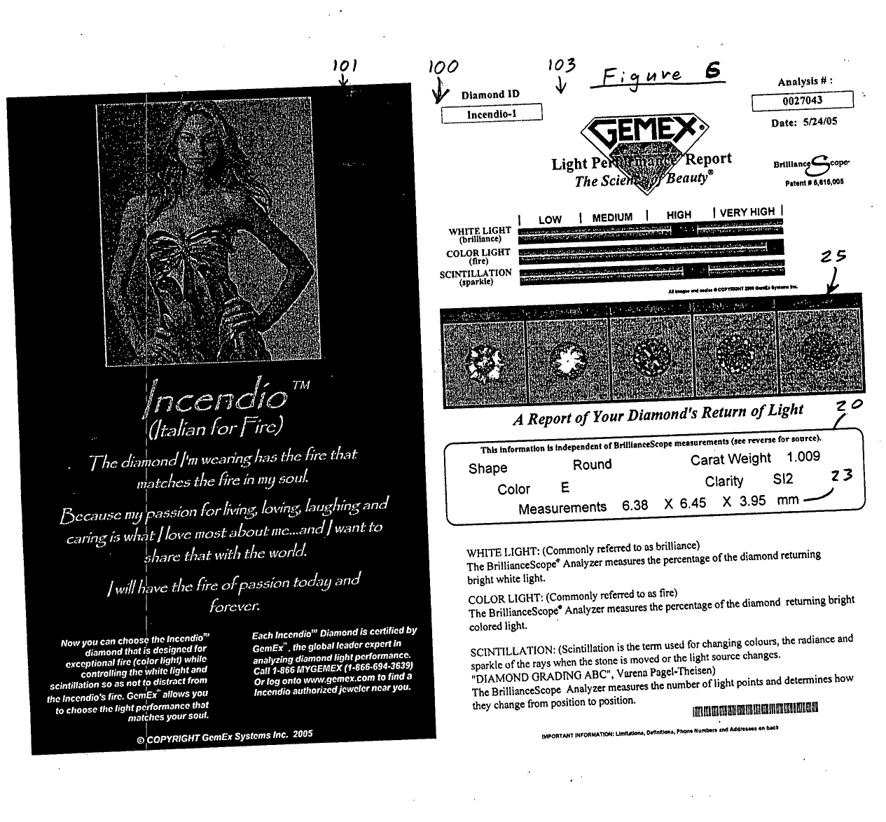

The present invention pertains to the process of generating a personalized gemstone certificate card (PGCC) as generally shown in FIG. 3 and 4 and the PGCC document 100 such as those generally shown in FIGS. 5 and 6. Gemstone cutting factories 10 produce cut gemstones and diamonds 15. The factories 10 grade these gemstones 15 or send them to a laboratory to have them graded. Graded gemstones receive a conventional grading certificate as shown in FIG. 1 that is matched with its respective gemstone 15. The grading certificate includes grading information 20 such as the color, clarity, carat weight and cut of the gemstone, and measurement information 23 regarding the physical dimensions and geometry of the gemstone, such as the size and shape of its table. Gemstones such as diamonds 15 are frequently evaluated by a light performance instrument 17 that produces the light image information 25 for the gemstone that shows the appearance of the gemstone under one or more lighting conditions. Some gemstone grading certificates include this light performance information 25 as shown in FIG. 2.

When the factory or gemstone manufacturer 10 sells the gemstone 1 5, it passes through a distribution channel and ultimately to a retail store 30. A person or purchaser 40 will visit the retail store 30, select a particular gemstone 15 and purchase it. Frequently, the purchaser 40 buys the gemstone 15 to give as a gift to another person 50 to commemorate a special occasion 55. For example, a groom 40 customarily buys a diamond for mounting in a ring to give to his bride 50 to commemorate their weeding 55. The diamond 15 symbolizes the love, devotion and dreams of the newlyweds. Accordingly, the diamond 15 holds a great deal of sentimental value that is difficult to capture, particularly when the diamond is passed down from one generation to the next.

The purchaser or benefactor 40 has access to a computer such as their own conventional personal computer 42. This remote computer 42 has an associated processor, memory and monitor 45 or other visual communication device capable of displaying images and text. The images can be black and white or color images, and can include photographs, graphic or other visual images. The computer 42 includes a data entry device such as a keyboard 46 for entering written text, and preferably includes an audio communication device such as a speaker for playing a sound recording stored on its or an associated memory. The computer 42 has access to personal picture files 56 that include photographs from or about the benefactor 40, recipient 50 or occasion 55, and text files 57 that include poems or text of the benefactor or recipient or in the public domain that are of sentimental value or importance to or describe the benefactor, recipient or occasion. The computer 42 also includes an associate printer, is in electrical communication with or linked to the internet 60 and includes a web browser. Although not shown in FIG. 3, the recipient also has access to a similar remote computer 42 such as a home personal computer or otherwise that is linked to the internet 60 and includes a web browser.

Gemstone grading 20 and measurement 23 information is sent from the factory 10 to a facility 70 or information center. This facility 70 has the roll of producing or assisting in producing an appropriate certificate for the purchased gemstone 15. This information 20 is depicted on the certificate shown in FIG. 1. The factory 10 can include light performance information 25 and additional measurement information 23 as depicted on the certificate shown in FIG. 2. The factory 10 or its associated laboratory sends this information 20, 23 and 25 to the facility 70 electronically, such as in the form of an electronic file or files, such as an e-file. Each gemstone 15 has its own related e-file or files 20e, 23e, 25e containing this information 20, 23 and 25. The facility 70 has a computer system 71 that includes a processor and associated memory 73 and database for storing these e-files 20e, 23e and 25e. The computer system 71 includes an associated server 75 that is communicatively linked to the internet 60. The computer system of the factory 10 is also preferably linked to the internet 60 so that the factory 10 can send the e-files 20e, 23e and 25e to the facility 70 via the internet.

The associated server 75 hosts a website 80 that is communicatively linked to the internet 60. The associate server 75 is in communication with and allows controlled access to portions of its computer system 71 and memory 73 of the facility 70. The website 80 allows a person such as the gemstone purchaser 40 to activate and run a software program 82 for designing a personalized gemstone certified card or PGCC document 100 as discussed below. When the program 82 is activated or run by the purchaser 40 via the website 80 and their computer 42, it prompts the user 40 for a name and diamond identification number, or some other number identifying the specific gemstone 15 or its manufacturer supplied gemstone information such as a gemstone certificate identification number. After entering the name and identification number, the program 82 displays a template on the monitor 45 of the personal computer 42 of the purchaser 40, who can then begin creating their own personal PGCC document 100. The template includes fields for entering sentimental pictures or graphic images and text.

The PGCC document 100 has a personalized section 101 and a grading section 103. The images and text can be selected from a stock library 85 of picture files 86, poem and text files 87, layout and color files 88, and music and audio files 89, and inserted into the personalized section 101. The program 82 also allows the program user 42 to insert personal pictures files 56 and text or poem files 57 into this personalized section 101. The grading section 103 contains the grading and measurement information 20 and 23, and can include light image information 25 as shown in FIG. 5 and 6. The program 82 merges the information 20, 23 and 25 to form a single merged PGCC document 100.

The computer system 71, website 80 and program 82 allow the user 42 to save a complete or partially complete template to an on-line, achievable database 90. The user 42 can then reenter the website 80 to retrieve and complete the template to create their electronic PGCC document 100, which can be printed as a paper PGCC document 105 by their computer 42 and saved in the on-line, achievable database 90. By entering a name and identification number, the recipient 50 of the gemstone 15 or another person, can retrieve and view the electronic PGCC document 100 from their personal computer. If desired, the purchaser 40 or recipient 40 can order a professionally printed PGCC 107 printed on a professional printing and laminating machine 112. The printed PGCC 107 is placed in an envelop 115 and mailed to the purchaser 40 or recipient 50.

### Process of Generating a PGCC

Although the process of generating a PGCC should be evident from the above, the following is provided to assist the reader. Although the author of the PGCC document 100 is generally the purchaser 40 of the gemstone 15, it should be understood that the author could be another person, such as a more computer knowledgeable relative or friend. The author 40 is able to access the PGCC design software 82 via an internet 60 connection to the server 75 and web-site 80 designated by the facility 70 to provide the PGCC functionality.

As shown in FIG. 4, upon logging onto 200 the web-site 80, a first level of options 210 appears on the screen 45 of the author 40. On this introduction screen 210 to the PGCC design program 80, the author 40 inputs personal data useful to create the PGCC document 100, and for billing. This personal information includes the name, street and e-mail address of the author 40, and shipping and billing addresses of the author, if different. The author 40 is also prompted 220 to enter a certification report identification number or ID for the specific gemstone 15 that was purchased and for which gemstone certification report is desired. The author is then prompted to select 230 the type of certification report they want, and is given the option to purchase a standard report 234 such as shown in FIG. 1 or 2, or create a PGCC report 235 such as those shown in FIGS. 5 and 6. The author is then ready to start designing 240 the PGCC report 100, 105.

As the first step 241 in designing the PGCC document 100 or 105, the author 40 elects the physical size of the PGCC document and a basic format from the pre-programmed themes or templates 242, or the option to design their own theme or template. The author 40 follows a pre-programmed routine of selecting the sentiment, style, video and picture files 56 or 86, text or poem files 57 or 87, and music or audio files 89 for inclusion in the PGCC 100, and designates where on the template each of these elements is to be located 243-248. The sentiment and style elements may be for example, a birthday card style or a humors style. Each of the template elements has multiple choices available from stock library 85 of design features, or the author 40 may select to use custom elements such as 56 and 57 that they provide to the design software 80. The author 40 can also up-load or otherwise provide any custom elements 249 of the PGCC 100 they want to add, such as their own text or poems 56, digital photographs or videos 57, or music or audio files. The author 40 is required to either provide their own elements 56 and 57, or use the elements 86-89 available from stock library 85 accessible via the website 80 and design software 82.

Upon completing the design layout phase 240 of the software routine 82, the author 40 is prompted to select the options for delivering the electronic PGCC document file 100, or the printed form of the document 105, or both 250. The author 40 is also prompted 260 to indicate if the PGCC document 100, 105 is for themselves, or is to be included with the gemstone 15 as a gift to another person 50. If the gemstone 15 and certification report are for a gift, the system 82 prompts 262 the author 40 for the name and address information of the planned recipient 50, and the method of delivery 264. Although the step 260 is described as being after the creation of the PGCC document file 100, it should be understood that this step could take place before the creation of the PGCC document. The author 40 is then given the final tally of the cost based on the delivery method and number of copies, etc.

Upon accepting the final PGCC document 100 delivery options 260 and confirming the price, the author 40 is prompted to close the transaction in the traditional electronic shopping cart routine for internet purchase transactions 270. That is, the author 40 is transferred to a secure e-commerce web page and the final inputs are made for credit card purchases. When complete, the author 40 is emailed a receipt for the transaction along with special instructions for accessing the PGCC document file 100 electronically in the on-line achievable database 90.

Upon completing the credit card transaction, the PGCC file 100 is locked and saved in the on-line archive 90 maintained by the facility 70 for these PGCC files and other gemstone reports related to the facility 290. If the author 40 has selected to order the printed version of the PGCC 105, the facility 70 sends the printing instructions to its remote printing facility, the PGCC document is printed, placed in an envelope 115, and then sent via mail or courier according to the authors choice. A typical printed PGCC 105 will not include all of the elements of the electronic PGCC file 100, especially in the case of music, audio, and video elements, if any were used.

After completing this design and purchase, the author 40 is then able to revisit 300 the web-site 80, log on by identify themselves and the report ID, accessing the PGCC file 100 in archive 90, view the full electronic PGCC file 100, order more copies 105, 107, or choose to make a new PGCC file 100 with additional or different design elements.

While the invention has been described with reference to a preferred embodiment, it will be understood by those skilled in the art that various changes may be made and equivalents may be substituted without departing from the broader aspects of the invention.

We claim:

1. A personalized gemstone certificate card generated by an author for a benefactor to give with a gemstone to a recipient to commemorate the gift or gift occasion, the author having access to a remote computer with a visual display, data entry device and web browser, said computer being interactively connected to the internet, said personalized gemstone certificate comprising:
a viewable document containing gemstone grading information, gemstone measurement information and personal information;
said gemstone grading information including color, clarity, caret weight and cut information pertaining to the gemstone;
said measurement information including dimensional information pertaining to the gemstone;
said personal information pertaining to at least one of the benefactor, gemstone, recipient and gift occasion, and,
said viewable document being a single merged document generated via a host server with an associated web enabled software program adapted to merge said gemstone grading information, gemstone measurement information and personal information into said single merged document.

2. The personalized gemstone certificate card of claim 1, and wherein said viewable document contains light performance images including color images depicting the gemstone under different lighting conditions, and said host server merging said light performance images into said viewable document.

3. The personalized gemstone certificate card of claim 1, and wherein said host server is adapted to be interactively connected via said associated software program to stock inventory containing text and poem files, picture image or video files, and audio or music files.

4. The personalized gemstone certificate card of claim 1, and wherein said viewable document is an electronic file, said electronic file being viewable via the internet on said computer of said author or a second remote computer with a visual display, data entry device and web browser.

5. The personalized gemstone certificate card of claim 4, and wherein said second computer is one of either a PDA and a cellular phone.

6. The personalized gemstone certificate card of claim 4, and wherein said electronic file is a printable electronic file.

7. The personalized gemstone certificate card of claim 6, and wherein said viewable document is a printed greeting card, said printed greeting card being printed on demand using a printing device associated with one of either said remote computer of said author or said second remote computer.

8. The personalized gemstone certificate card of claim 1, and wherein said viewable document is a printed greeting card, said printed greeting card being professionally printed in a remote facility on specialized equipment for producing greeting cards and gemstone grading certificates.

9. The personalized gemstone certificate card of claim 1, and wherein said personal information includes picture, text and video files selected from pre-programmed options selected from the website and linked to a downloadable stock database inventory of pictures, text and video files to personalize and relate the gemstone to a specific event, occasion, or sentiment as determined by the author.

10. The personalized gemstone certificate card of claim 1, and wherein said personal information includes personal text and one of either picture image and video files input by electronic file transfer by the author to personalize and relate the purchase of the gemstone to a specific event, occasion, or sentiment as determined by the author.

11. The personalized gemstone certificate card of claim 1, and wherein the author is a gemstone retailer, and said software allows said retailer to design, order and pay for the viewable document on-line using an on-line electronic “shopping cart” software package.

12. The personalized gemstone certificate card of claim 1, and wherein the author is a customer, and said viewable document is design by said customer on-line using a browser linked to said host server, and wherein said viewable document is ordered and paid for on-line using an on-line electronic “shopping cart” software package.

13. The personalized gemstone certificate card of claim 1, and wherein the gemstone is a diamond, and the personalized gemstone certificate card is a personalized diamond certificate card.

14. An on-line process of generating a personalized gemstone certificate card from a personal computer of an author, the personal computer having a visual display and data entry device and being communicatively linked to the internet, the personalized gemstone certificate card being given by one of either the author and a benefactor with a specific gemstone as a gift to a recipient, said on-line process comprising the steps of:
providing a website posted on a server that is communicatively linked to the internet, a stock library of text and image files and a memory containing gemstone information for a plurality of gemstones including the specific gemstone being gifted, said gemstone information being supplied by a manufacturer for that said gemstone, said website being adapted to run an associated software program to provide a template with various fields for inserting text and image files, said program allowing access to and receipt of said stock library of text and image files and access to an on-line achievable database, said program further allowing receipt of personal text and picture files from the personal computer; and
said program further allowing access to the gemstone information for the specific gemstone being gifted;
requesting one of either purchaser and author identification information;
requesting specific gemstone identification information;
displaying a template with a plurality of fields for entering text and image files;
selecting and inserting for each of said fields of said template one of either said text and image files, each of said text and image files coming from one of either said stock library and said personal text and image files;
completing each of said fields to generate an electronic personalized gemstone certificate card file having a personalized section and a gemstone certificate section, said gemstone certificate section containing said gemstone information for said specific gemstone being gifted; and,
saving said electronic personalized gemstone certificate card file to said on-line achievable database, said website and program allowing said author and recipient access to said electronic personalized gemstone certificate card file upon entering said one of either purchaser and author identification information and said gemstone identification information.

15. The on-line process of claim 14, and wherein said at least one of said plurality of fields of said template is adapted to receive an audio or video file.

16. The on-line process of claim 14, and wherein said gemstone information provided in said gemstone certification section is as supplied by said gemstone manufacture.

17. The on-line process of claim 14, and wherein the gemstone is part of a jewelry piece.
